(19) United States
(12) Patent Application Publication
(10) Pub. No.: US 2012/0239302 A1
(43) Pub. Date: Sep. 20, 2012

(54) APPARATUS AND METHOD FOR MEASURING LIQUID LEVEL IN A WELL

(76) Inventors: Noam Amir, Ness-Ziona (IL); Tal Pechter, Ramat-Hasharon (IL)

(21) Appl. No.: 13/505,840

(22) PCT Filed: Oct. 26, 2010
(86) PCT No.: PCT/IL10/00884

§ 371 Date: May 3, 2012

Related U.S. Application Data
(60) Provisional application No. 61/257,860, filed on Nov. 4, 2009.

(51) Int. Cl. G06F 19/00; G01V 1/40

(52) U.S. Cl. 702/11; 702/97

(57) ABSTRACT

The distance between a reference point and a target surface in a void, such as a well or tank, is measured accurately without having to identify the ambient condition within the void, the ambient temperature inside the void for example. A signal is generated and transmitted through a medium towards the target surface. The target surface comprising a substance that will reflect the signal. The time the signal was transmitted is known and a reference point relative to a detection device is also known. For example, the detector may be the reference point. The detector detects a calibration signal that is reflection of the generated signal off of a calibrated-constrictive element located at a known position relative to the reference point. A measurement signal that is reflection of the generated signal resulting from the generated signal striking the target surface is also detected. The distance measurement is determined based upon this information.

### CROSS-REFERENCE TO RELATED APPLICATIONS

This application is filed in the United States Patent Office under 35 USC 371 as a national application of the Patent Cooperation Treaty application filed under Article 3 of the Patent Cooperation Treaty and assigned International Application Number PCT/IL2010/000884, which application claims priority under Article 8 of the Patent Cooperation Treaty and Article 4 of the Paris Convention of the prior filing date of the United States Provisional Application for patent that was filed in the United States Patent Office on Nov. 4, 2009 and assigned Ser. No. 61/257,860, which applications are hereby incorporated by reference in their entirety.

### BACKGROUND

The present disclosure is related to identifying the level of a liquid or other substance existing in a hole, well or container and, more specifically, a technique to accurately identify the level of such substance regardless of temperature fluctuations during measurement times and automatically maintaining calibration.

From early ancient times, mankind has depended on submerged sources of water that are accessed from the surface by tapping into the sources through wells. In addition, other submerged elements, such as oil, ore, coal, precious metals, etc. are retrieved from subterranean environments through the digging and/or drilling of wells, as well as caves. In addition, there are many other scenarios in which the volume of contents of a container or the level of a substance in a container cannot readily be ascertained but rather, must be measured in some manner. For instance, water towers that are located significantly above the ground, gasoline tanks buried in the ground, landfills, etc. Thus, there is a need in the art for monitoring the surface level of liquid or substance existing in a container or well.

For liquid based wells or containers, generally a pump is used to extract the contents. One reason for determining the level of the contents of such wells and containers is that if the level drops below the inlet for the pump, the pump can burn out or become damaged. Some pumps are equipped with shut off switches but, failure of this mechanism is possible. Being able to accurately identify the level of the contents can provide early notice regarding remedial measures that should be taken, such as lowering the pump or turning off the pump to allow replenishment of the well.

There are several prior art techniques that have been introduced and utilized for measuring the surface level of a substance. Some of these technique employ the use of acoustic pulses that are transmitted or introduced into the well or container. The round trip travel time of these acoustic pulses from a reference point to the surface of the substance and then back again is measured. These measurements can be made by using a microphone, or in some instances, multiple microphones to detect the acoustic pulses and their reflections. Other prior art techniques include the use of pressure sensors which must be lowered down and submerged below the liquid or substance surface. Another technique specific for use with liquids includes the use of a float that can rise of fall with the liquid level and provide an indication of the current level. Another technique requires a pair of wires to be lowered all the way down to the liquid or substance level, at which point the liquid or substance operates to close a circuit which can result in illumination of an indicator lamp.

Each of these techniques, as well as other prior art techniques, suffer from deficiencies such as the dependence of the readings on ambient temperature, the necessity to use multiple microphones, or the necessity to submerge electronic equipment all the way down beneath the liquid or substance surface.

With regards to the ambient temperature readings, some measuring techniques, such as acoustic pulses, will have varying results depending on the temperature within the container. As such, to obtain accurate level readings, the ambient temperature must also be measured and then the level reading adjusted based on the ambient temperature. With regards to techniques that require equipment to be lowered into the well or container, it should be appreciated that such actions can be difficult and, creates a risk of getting jammed or stuck in the tube thereby preventing further access to the substance, as well as the risk of introducing contamination into the substance. Further, if the well access is used for retrieving the substance, in order to make the measurements it may be necessary to cut off access to the substance during measurement times. Furthermore, lowering equipment into a well is an inadequate technique because there is a limited in range in which the measurements can be taken. In addition, it should be appreciated that lowing equipment into a well also requires a human operator to lower wires and take a manual reading. Furthermore, in other embodiments, such as raised water tanks, submerged tanks, etc., it simply may not be practical to obtain physical access for making measurements.

Therefore there is a need in the art for a technique that will measure the surface level in a deep container, a well or other container, from a reference point such as the ground level or the container wall/top, and once installed, operates without human intervention. The measurement has to be accurate by automatically compensating for temperature fluctuations. Furthermore, there is a need for a system that can be installed easily in a well.

### BRIEF SUMMARY

The present disclosure describes embodiments of devices and methods to measure the distance between a reference point and a target surface in a void, such as a well or tank, without having to identify the ambient temperature within the void. Advantageously, such a technique eliminates equipment and acts required in making such measurements. A signal is generated and transmitted through a medium towards the target surface. The target surface comprising a substance that will reflect the signal. The time the signal was transmitted is known and a reference point relative to a detection device is also known. For example, the detector may be at the reference point. The detector detects a calibration signal that is reflection of the generated signal off of a calibrated-constrictive element located at a known position relative to the reference point. A measurement signal that is reflection of the generated signal resulting from the generated signal striking the target surface is also detected. The distance measurement is determined based upon this information. Exemplary calibrated-constrictive elements can be such as but not limited to: a ring, a rod, a lump of metal, etc.

Throughout the disclosure the term well and deep container can be used interchangeably and the term well can be used as a representative term for any type of well or deep container.

The disclosure describes different embodiments of an apparatus that can be mounted at a reference level such as ground level and measures the liquid surface level by sending acoustic waves down a tube going into the well and having a calibrated-constrictive element located at a known position relative to the reference level, and measuring the time it takes for the wave to propagate down the tube and back up from the calibrated-constrictive element and after being reflected from the liquid's surface.

In order to overcome effects of temperature on the speed of sound, exemplary embodiments can include a self-calibration mechanism to compensate for variations in temperatures. An exemplary self-calibration mechanism may include one or more constrictions along the tube. In some embodiments the constrictions can include one or more rings that can be suspended on a string inserted in the tube. Each one of the constrictions can be located at a predefined distance from a reference point on the string. Those constrictions can be used as calibrated-constrictive element at certain locations along the tube.

In another exemplary embodiment a tube having one or more built-in constrictions can be used. The one or more built-in constrictions can be at predefined distances from the top of the tube.

### BRIEF DESCRIPTION OF THE SEVERAL VIEWS OF THE DRAWING

FIG. 1 is a block diagram illustrating an exemplary level measuring apparatus deployed within a well environment.

FIG. 2 is a flow diagram illustrating the acts involved in an exemplary implementation of a level measuring apparatus that specifically operates to compensate for temperature fluctuations.

FIG. 3 is a block diagram showing another embodiment of the measuring device.

FIG. 4 is an exemplary embodiment of the measuring device implemented in a water tank environment.

FIG. 5 is a functional block diagram of the components of an exemplary embodiment of the measuring device 110, 410, as well as other embodiments thereof.

### DETAILED DESCRIPTION OF EMBODIMENTS OF THE INVENTION

The present disclosure presented embodiments, as well as features and aspects thereof, related to a system and method for measuring substance levels in wells, tanks, caves, etc., as well as for measuring depth or distance in a container, well, hole, cave, etc. In general, although the practice of utilizing the propagation delays of acoustic waves to measure distance is well known, the embodiments described present a new and novel technique of utilizing such technology in a manner that automatically calibrates measurements based on the temperature in the environment or, in essence temperature agnostic measuring technique.

One embodiment can be described as a measurement apparatus. The measurement apparatus or device measures the distance between a reference point and a target surface of a material that has properties necessary to reflect a signal. The apparatus includes a signal generator, a detector and a processing unit. The signal generate operates to generate a signal and transmits the signal through a medium towards the target surface. The detector operates to detect when a signal passes by a transducer. The processing unit is communicatively coupled to the detector and in some embodiments, also the generator. The processing unit first receives a signal indicating the detection of a calibration signal. The calibration signal is an output of the detector that is generated by the detection of a reflection of the generated signal when the generated signal bounces off a calibrated-constrictive element that is located at a known position relative to the reference point. In addition, the processing unit receives a measurement signal. The measurement signal is an output of the detector that is generated by the detection of a reflection of the generated signal when the generated signal bounces off of the target surface. At this point, the processing unit knows the time that it took the calibration signal to propagate from the reference point, to the calibration point and back to the reference point, the distance between the reference point and the calibration point, and the time that it took for the measurement signal to propagate from the reference point, to the target surface and back to the reference point. With this information, the processing unit is operable to generate a measurement of the distance between the reference point and the target surface based on the time the measurement signal was received and the determined propagation speed of the calibration signal. The processing unit can then provide this distance measurement as an output in a variety of fashions.

More specifically, one embodiment of the signal generator may include a digital-to-analog converter, an amplifier and a transducer. In such an embodiment, the processing unit has an output that is coupled to the input of the digital-to-analog converter and, the output of the digital to analog converter is coupled to the input of the amplifier. The output of the amplifier is coupled to a transducer. In operation, the processing unit generates a digital signal which is provided to the digital-to-analog converter and an analog output signal is provided to the amplifier. The amplifier amplifies this signal and then provides it to the transducer which then generates the signal. For example, if the transducer is a speaker, the generated signal is acoustic.

An exemplary embodiment of the detector includes an analog-to-digital converter, an amplifier and a transducer. For example, for acoustic signal the transducer is a microphone. The transducer includes an output that is coupled to the input of the amplifier and, the output of the amplifier is coupled to the input of the analog-to-digital converter. Finally, the output of the analog-to-digital converter is coupled to an input of the microprocessor. In operation, a signal that passes by the transducer excites the transducer to generate an analog signal. This analog signal is provided to the amplifier and then the amplified signal is provided to the analog-to-digital converter. The output of the analog-to-digital converter is provided to the processor which can recognize the signal as either a calibration signal or a measurement signal.

The processing unit can make this determination in a variety of manners. For example, in one embodiment, the processing unit assumes that the first signal received after the generation of the signal will be a calibration signal. Subsequent to the calibration signal, the processing unit then assumes the next signal received will be the measurement signal. In other embodiments in which multiple calibration signal may be used, the processing unit looks for the reception of each signal in order. However, on some embodiments, due to ambient noise and other factors, a signal may fail to be detected. In this scenario, the processing unit can apply heuristics to either differentiate the signals and/or provide an error indication.

For instance, if the processing unit only receives one signal after a prolonged period of time, the processing unit can conclude that a signal has been lost. At this point the processing unit can simply flush the current reading and start over again or, apply heuristics to determine if the received signal is a calibration signal or a measurement signal. For instance, if prior measurements have been made, if the propagation time for the received signal approximates the time for previous calibration signal measurements, the processing unit can conclude this is a calibration signal. Likewise, if the propagation time of the received signal approximates that of recently received measurement signals, then the processing unit may conclude the signal is a measurement signal. In the former scenario, the processing unit may simply store the information regarding the calibration signal for use in trending and analysis and then initiate or wait for the next measurement cycle. In the later scenario, the processing unit may proceed to make a measurement determination based on recently received calibration signals. In some embodiments if the processing unit only receives one signal after a prolonged period of time, the processing unit can conclude that a signal has been lost and retransmit with higher acoustic energy, for example.

The processing unit can determine the propagation speed of the calibration signal by determining a time offset between the time stamp that the calibration signal was received relative to a known time at which the generated signal was transmitted and then determining the speed of the generated signal and calibration signal.

The processing unit can generate a measurement of the distance between the reference point and the target surface by determining a time offset between the time stamp of the measurement signal and the known time at which the generated signal was transmitted and using the determined propagation speed to determine the distance.

The reference point may be the point at which the transducer injects the signal, the point at which the detecting transducer is located or a point relative to either or both of these elements.

Another embodiment presented in the disclosure includes a technique for measuring a distance between a reference point and a target surface within a void by determining a time offset between the time stamp of the measurement signal and the known time at which the generated signal was transmitted and using the determined propagation speed to determine the distance. More specifically, this embodiment operates to generate a signal, such as an acoustic signal and transmit that signal at a known position relative to a reference point. The signal is injected into a proximate end of the void toward the distal end towards the target surface. Next, at least one calibration signal is received. The calibration signal is a reflection of the signal resulting from the signal striking or bouncing off of a calibrated-constrictive element that is located at a known position in the void relative to the reference point. In addition, a measurement signal is also received. The measurement signal is a reflection of the signal resulting from the signal striking or bouncing off of the target surface. Based on the known distance from the reference point to the calibration point and the measured time between injecting the signal and receiving the calibration signal, the propagation speed of the calibration signal is determined Using this information, the distance between the reference point and the target surface based on the time that the measurement signal was received and the determined propagation speed can be determined.

Now, turning to the figures in which like numbers represent like elements, various embodiments, features, aspects and functions of the above-described measuring device, system and techniques are presented.

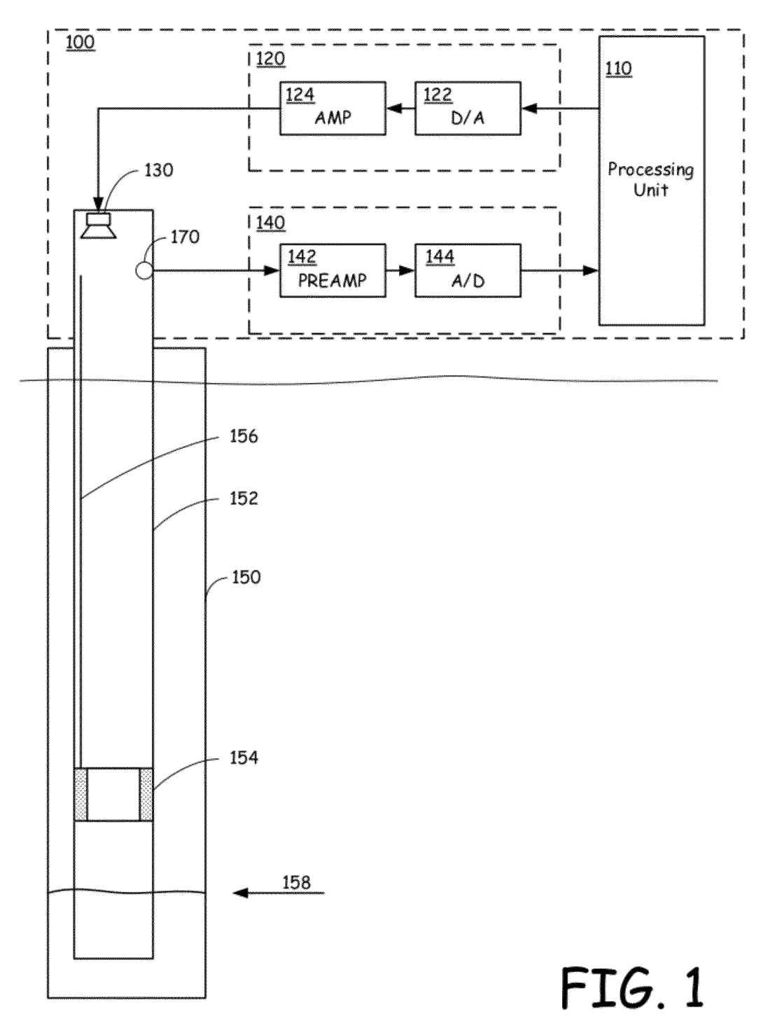

FIG. 1 is a block diagram illustrating an exemplary level measuring apparatus deployed within a well environment. The exemplary measuring system can be an acoustic-pulse-reflectometry system. In the illustrated embodiment, the well as shown as a cross-sectional view. The measuring device 100 is shown as including a processing unit 110 that interfaces to a signal generator 120 and a signal detector 140. The processing unit 110 interfaces to a transducer, such as a speaker 130, through the signal generator 120. In the illustrated embodiment, the signal generator is shown as including a digital-to-analog converter 122 and an amplifier 124. In such an embodiment, the processing unit may provide a digital signal to the input of the digital-to-analog converter 122, which then converts the signal to an analog signal and provides this analog signal (typically an acoustic signal, although it is anticipated that the analog signal may be an RF signal, ELF, UHF, optical, etc. signal) to the amplifier 124 if necessary. After amplification, if necessary, the signal is then transmitted through a medium towards a target, such as a substance level, surface or object, such that the distance from a known or reference point to the target can be ascertained. For instance, the signal may be provided to a transducer 130 that converts the signal into an acoustic or sound signal that is transmitted through the air, such as in a well. However, the signal may also be provided to an antenna for transmission or a light source, such as an LED or IR-LED. Furthermore, the processing unit 110 also interfaces to signal detector 140. The signal detector 140 is illustrated as interfacing to a transducer, such as a microphone 170, through a preamplifier 142 and an analog-to-digital converter 144. In the illustrated embodiment, a signal detected or present at the microphone 170 would excite the microphone causing it to generate an analog signal. This signal may then be amplified at preamplifier 142 then provided to the analog-to-digital converter where it is converted into a digital signal that can be processed by the processing unit 110. It should be appreciated that the processing unit may be as simplistic as a microprocessor, microcontroller, ASIC or other control circuitry, or may be a small computer, personal computer, handheld device, desktop computer or any of a variety of computing environment. As such, any or all of the components, including the digital-to-analog converter 122, amplifier 124, preamplifier 142, analog-to-digital convert and, even the speaker 130 and microphone 170 can be an integral part of the processing unit 110 or, exist separate from the processing unit 110 as illustrated in the embodiment of FIG. 1. In an integrated embodiment, the entire measuring device 100 can be placed in association with the well or container in which the measurements are being taken. In addition, any of a variety of configurations for the signal generator 120 and the signal detector 140 are anticipated, including black boxes, off the shelf components, fully integrated circuitry, etc.

As a specific application, the measuring device 100 in FIG. 1 is shown as operating in the environment of a well that includes a well casing 150. The speaker 130 and the microphone 170 are attached to a tube 152 that exists or has been inserted into the well casing 150. Furthermore, a constricting device such as a ring, etc. 154 is shown as having been inserted into the tube 152 and is attached to a string or chord 156 for removing or extracting of the ring 154. The distance that the ring 154 is lowered into the tube 152 is a known and constant number because the length of the string 156 is known. The constriction created by the ring 154 should reside above the surface level 158 of the substance in the well. It should be appreciated that the environment illustrated in FIG. 1 is used for illustration purposes only and therefore is not shown in proportion. For example, the distance between constriction ring 154 and the ground level is substantially shorter than the distance between the surface level 158 of the substance and the ground level. Other exemplary embodiments may use other type of constricting devices such as a rod, a lump of metal, etc.

In operation, in which a constricting device is not used, a signal is created by the processing unit 110, converted to an analog or audio signal and used to excite the speaker 130, thereby causing an acoustic signal to be transmitted down the tube 152. The tube 152 extends from at or above ground level to below surface level 158 of the substance. The microphone 170 or similar transducer or acoustic wave detector is introduced into the tube 152 to detect acoustic waveforms. The microphone can be mounted to the wall of the tube 152, extending into the tube through the top or through an aperture drilled, bored, etc., into the wall of the tube 152 or otherwise introduced into the tube 152. The acoustic wave created by exciting the speaker 130 is detected by the microphone 170 as it propagates down the tube 152, causing a signal to be generated by the excited microphone and amplified, converted and presented to the processing unit 110 where the signal can be recorded as a first measurement. The acoustic wave continues to propagate down the tube 152 to the surface level 158 of the substance, and then the acoustic wave is reflected back up the tube 152. The reflected acoustic wave propagates back up the tube 152 where it then excites the microphone 170, thereby causing another signal to be generated, passed through the preamplifier 142, converted to a digital signal at the analog-to-digital converter 144 and provided to the processing unit 110. The signal is then recorded as a reflected measurement by the processing unit 110. The round trip travel time, determined as the difference in time of the reflected signal and the first signal, is used to calculate the distance between the microphone 170 and the surface level 158 of the substance.

It is well known that the speed that sound travels through a medium, among other things, is dependent upon temperature. As such, the accuracy of the above-described measuring device is limited due to fluctuations in the ambient temperature and the effect of those fluctuations on the speed of sound. The various embodiments of the present disclosure provide improved accuracy in the level measurements by automatically calibrating the measurements to the current temperature and/or making the measurements temperature agnostic. In essence, the various embodiments of the measuring device utilize a reflective element that is positioned at a known location relative to the microphone or transducers. The reflective element causes a reflection of the induced acoustical signal which can be easily compared to the signal reflected by the surface of the substance in the measured container or well. Thus, because the distance of between the microphone and the reflective surface is known, the current speed of sound, at the current ambient temperature, can be calculated based on the propagation delay experienced for the acoustic signal received from the reflective surface. This knowledge can then be used in solving the distance calculations for the acoustic wave reflected from the surface of the substance.

In the embodiment illustrated in FIG. 1, a ring 154, attached to string or chord 156, is lowered into the tube 152 a known distance and the ring 154 operates as a reflective surface or a constriction. Recording the reflections created by constriction ring 154 enables the system to self-calibrate by calculating the speed of sound at the time of measurement, and adjusting the calculation of distance to surface level 158 accordingly. More information on the operation of the exemplary acoustic-pulse-reflectometry system that is illustrated in FIG. 1 is described in the above-incorporated by reference U.S. patent application Ser. No. 11/996,503.

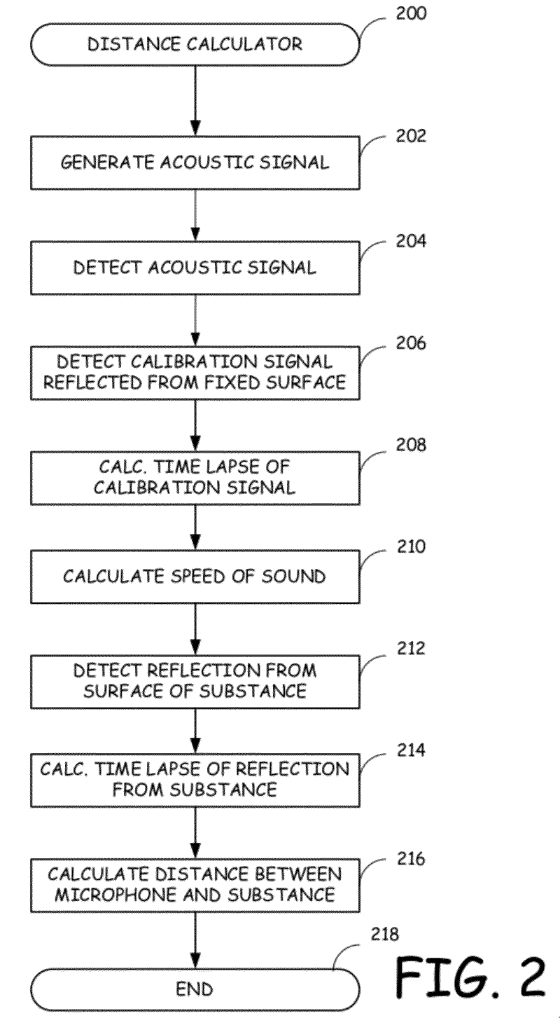

FIG. 2 is a flow diagram illustrating the acts involved in an exemplary implementation of a level measuring apparatus that specifically operates to compensate for temperature fluctuations. The illustrated procedure operates to accurately calculate the surface level 158 of the substance.

The distance measuring process 200 initially generates an acoustic signal 202 to be introduced into the upper portion of the pipe 152 that extends through the well casing 150. The acoustic signal may be generated in a variety of manners. A few non-limiting examples include the illustrated configuration in FIG. 1 in which a processing unit 110 generates a digital signal that is converted by the digital-to-analog converter 122 and then amplified by amplifier 124 prior to being used to excite speaker 130 to generate the acoustic signal. Another example may include a tone generator that is gated by a control signal from the processing unit such that the tone can be turned on (enabled) or turned off (disabled) depending on the state of the control line. The signal generated by the speaker 130 then begins to propagate down the pipe 152. As the signal passes the microphone 170, the microphone 170 is excited and generates an analog signal that is then provided to the preamplifier 142, converted to digital by the analog-to-digital converter 144 and then provided to the processing unit 110. The processing unit detects 204 this signal and identifies the timing of the signal as time point t0. It should be appreciated that in some embodiments, the act of detecting the originally generated signal can be omitted. In such an embodiment, the propagation delay from the speaker to the microphone is considered to be negligible and as such, when the processing unit 110 generates the signal, it identifies this as time point t0. The signal continues to propagate down the tube 152 where it hits the constriction ring 154 and a portion of the signal is then reflected and begins to propagate back up the tube 152 towards the microphone 170. This reflected signal is referred to as the calibration signal. The calibration signal excites the microphone 170 and is thus detected 206 by the processing unit 110 and its arrival time is identified as time point t1. The time lapse of the calibration signal can then be calculated 208, as well as determining the current speed of sound in the tube 152. Noting the time lapse between the instant when the original pulse is recorded t0 and the reflection from the constriction is recorded t1 as Tc, and the known distance from the microphone 170 to the constriction as Dc, the speed of sound ‘c’ can be found 210 to be c=(2×Dc)/Tc.

The original signal continues to propagate down the tube 152 and ultimately hits the surface of the substance 158. Again, a portion of the signal is then reflected by the substance and the reflected signal begins to propagate up the tube 152 toward the microphone 170. The calibration signal excites the microphone 170 and is thus detected 212 by the processing unit 110 and its arrival time is identified as time point t2. Noting the time lapse between the instant when the original pulse is recorded t0 and the reflection from the liquid level is recorded t2 as Tw 214, the distance Dw from the microphone 170 to the liquid level is now calculated 216: Dw=(c×Tw)/2. The distance calculation is then completed 218.

Thus, it should be appreciated that the illustrated process is able to accomplish two tasks. First of all, the distance to the surface level 158 of the substance is determined without having to measure and compensate for the ambient temperature within the tube 152. Secondly, the ambient temperature within the tube 152 can be determined mathematically by solving the speed of sound equation for the time variable. This aspect is advantageous as in some implementations, it may be beneficial to also know the ambient temperature as fluctuations in the ambient temperature may also have an effect on the volume of the substance within the well and thus, the surface level 158.

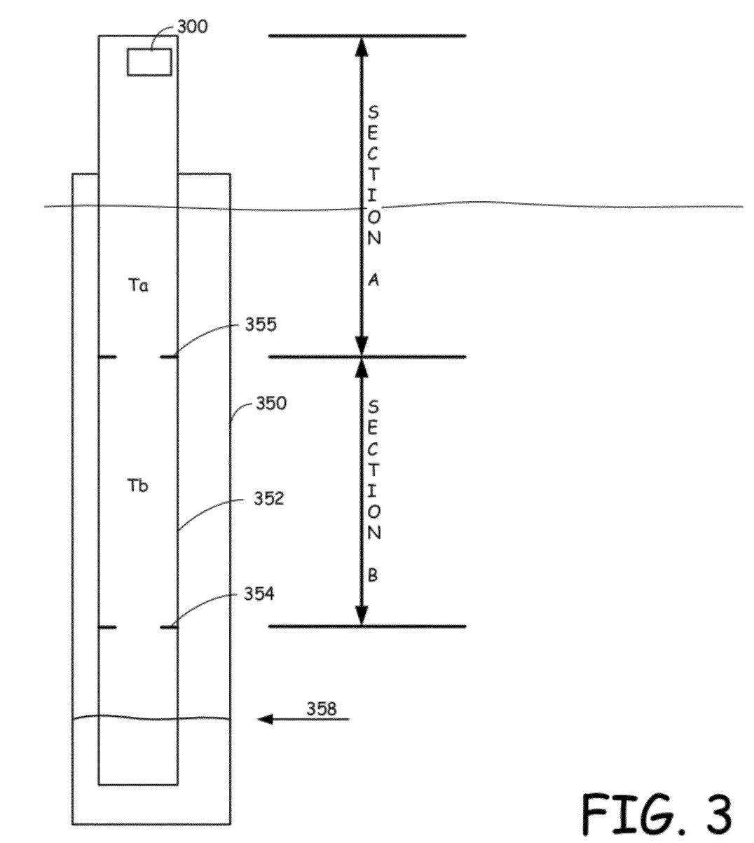

FIG. 3 is a block diagram showing another embodiment of the measuring device. In this embodiment a well casing 350 is shown with a tube 352 having been inserted to or below the surface level 358 of the substance. It should be noted that in this embodiment, as well as the other embodiments, the well casing 350 may simply be the walls of a dug or bored well, the interior walls of a container, or the like. In addition, in some embodiments, a tube is not necessary to be inserted into the well or container but rather the well or container walls are sufficient to include the constricting elements.

In the embodiment illustrated in FIG. 3, a measuring device 300 is shown as being fully mounted and contained within the tube 352. In such an embodiment, the measuring device can operate to generate the acoustic signals, detect the reflected signals and perform the calculations all within the device. The device can then be read to obtain the measurement information in any of a variety of manners, including but not limited to, attaching a computing device to the measuring device either by wire or wireless techniques, transmitting the data to a remote device, etc. In addition, the measuring device may simply be equipped with an alarm or light that are triggered when the level is above or below a desired threshold. It will be appreciated that measuring device can be programmed in a variety of manners to provide different indicators. For instance, a small display could provide the current level, the current ambient temperature, etc. The measuring device may simply transmit an alarm on or alarm off conditions or, provide more elaborate information such as content levels, time of day, ambient temperature, mean/average/deviation of level over periods of time, etc.

Further, in the embodiment illustrated in FIG. 3, two constricting devices are shown (354 and 355). In such an embodiment, two calibrating signals are received by the microphone and used in performing sound speed and/or temperature calculations. One or more constricting elements creating one or more calibration signals due to their ability to reflect the acoustic signal can be utilized in the various embodiments of the measuring device. Thus use of multiple constricting devices to generate multiple calibration signals may beneficially give a more accurate assessment of the speed of sound through the tube, well or container when the ambient temperatures vary at different depths.

For example, in the illustrated embodiment, Section A may have an average ambient temperature of Ta, whereas Section B may have an average ambient temperature of Tb. As a result, the speed of sound for the calibration signal reflected from constriction 355 is calculated as C_{Ta}, whereas the speed of count for the calibration signal reflected from constriction 354 is C_{Tab}. Having the knowledge of the distance of Section A and Section B, the speed of sound through Section B C_{Tb} can be derived from C_{Ta} and C_{Tab}. This information may then be applied to more accurately determine the surface level 358 by applying the variously determined speeds of sound to the various sections and then averaging or interpolating the speed sound attributed to the distance below the last calibration constricting device.

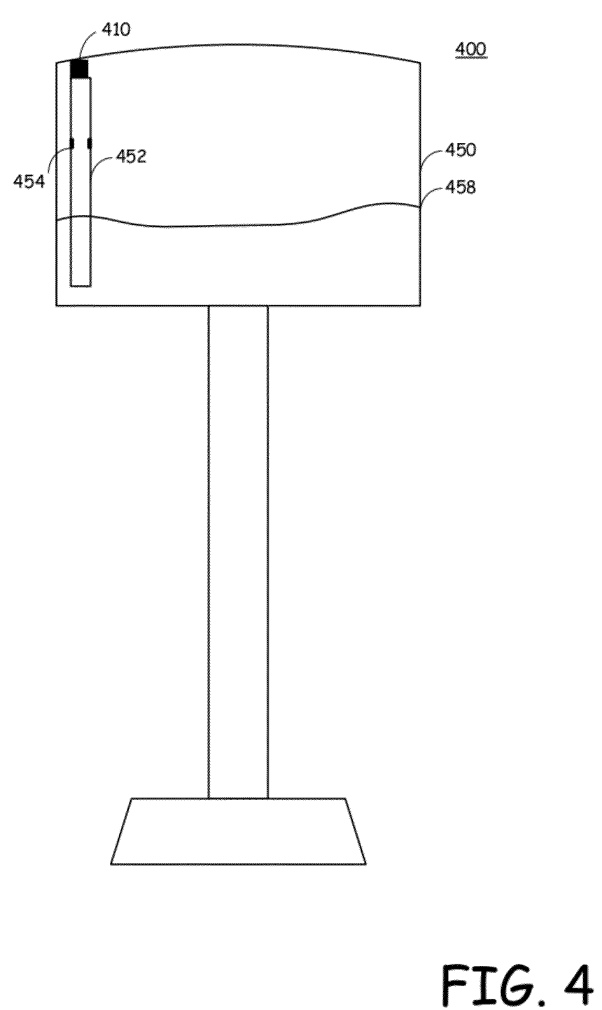

FIG. 4 is an exemplary embodiment of the measuring device implemented in a water tank environment. In the illustrated embodiment, a water tank 400 is shown as being elevated from the ground and having water contents at a current level 458. The measuring device 410 can be a self-contained embodiment that is mounted either on the interior of the tank 400 or, may also be mounted on the top or side of the exterior. A tube 452 including one or more constricting elements 454 is shown as extending from the top of the tank and sufficiently long enough to have the end submerged in the water. Advantageously, this embodiment allows the water level in the tank to be accurately measured agnostic to the current temperature in the tank. In addition, since it is well known that objects expand when heated and contract when cooled, the measuring device can also ascertain the temperature within the tank and account for the temperature fluctuations on the volume of water in the tank.

An additional exemplary embodiment of the measuring device may be a portable system with a display that provides user accessible depth readouts. Another exemplary embodiment can be permanently installed in association with a well or container and then operates to transmit the depth readings by some form of communication system to a central monitoring location.

A further exemplary embodiment of the measuring device with a self-calibration mechanism may include a plurality of constrictions along the tube. In some embodiments the constrictions can include one or more rings or rods that can be suspended on a string inserted in the tube or may be fabricated or attached permanently or semi-permanently to the wall of the tube. Each one of the constrictions in the stringed embodiment can be located at a known distance from a reference point on the string. In an embodiment having one or more built-in constrictions, the one or more built-in constrictions can be at predefined distances from the top of the tube.

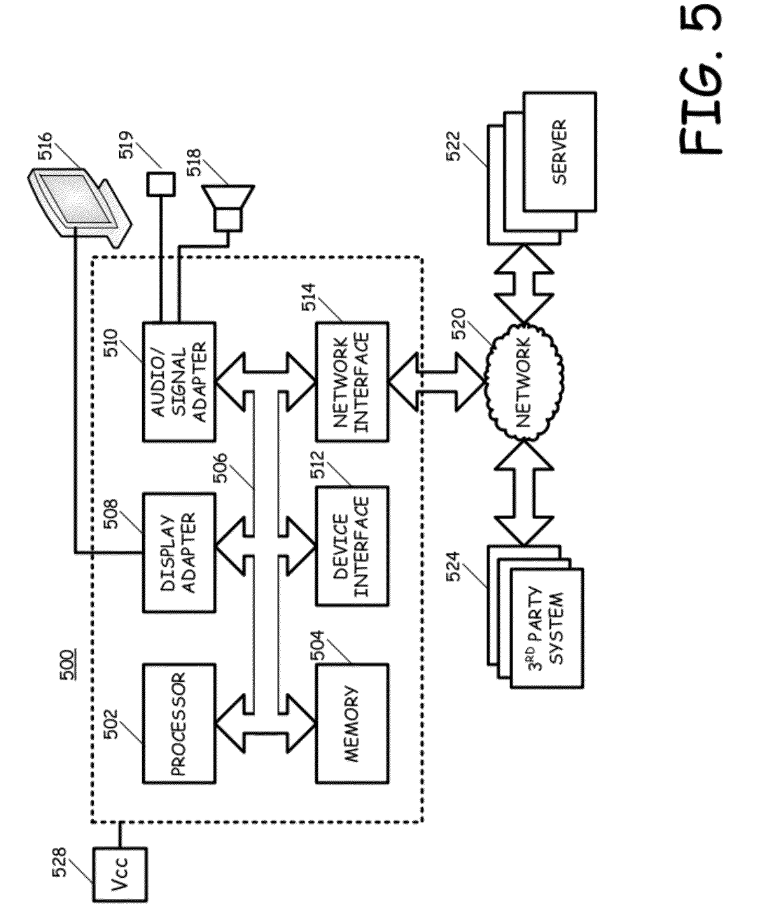

FIG. 5 is a functional block diagram of the components of an exemplary embodiment of the measuring device 110, 410, as well as other embodiments thereof. It will be appreciated that not all of the components illustrated in FIG. 5 are required in all embodiments of the measuring device but, each of the components are presented and described in conjunction with FIG. 5 to provide a complete and overall understanding of the components. The measuring device can include a general computing platform 500 illustrated as including a processor 502 and a memory device 504 that may be integrated with each other (such as a microcontroller) or, communicatively connected over a bus or similar interface 506. The processor 502 can be a variety of processor types including microprocessors, micro-controllers, programmable arrays, custom IC's etc. and may also include single or multiple processors with or without accelerators or the like. The memory element of 504 may include a variety of structures, including but not limited to RAM, ROM, magnetic media, optical media, bubble memory, FLASH memory, EPROM, EEPROM, etc. The processor 504, or other components may also provide components such as a real-time clock, analog to digital converters, digital to analog converters, etc. The processor 502 also interfaces to a variety of elements including a control or device interface 512, a display adapter 508, audio/signal adapter 510 and network/device interface 514. The control or device interface 512 provides an interface to external controls or devices, such as sensor, actuators, transducers or the like. The device interface 512 may also interface to a variety of devices (not shown) such as a keyboard, a mouse, a pin pad, and audio activate device, a PS3 or other game controller, as well as a variety of the many other available input and output devices or, another computer or processing device. The display adapter 508 can be used to drive a variety of alert elements and/or display devices, such as display devices including an LED display, LCD display, one or more LEDs or other display devices 516. The audio/signal adapter 510 interfaces to and drives another alert element 518, such as a speaker or speaker system, buzzer, bell, etc. In the various embodiments of the measuring device, the audio/signal adapter could be used to generate the acoustic signal from speaker element 518 and detect the received signals at microphone 519. The amplifiers, digital-to-analog and analog-to-digital converters may be included in the processor 502, the audio/signal adapter 510 or other components within the computing platform 500 or external there to. The network/device interface 514 can also be used to interface the computing platform 500 to other devices through a network 520. The network may be a local network, a wide area network, wireless network, a global network such as the Internet, or any of a variety of other configurations including hybrids, etc. The network/device interface 514 may be a wired interface or a wireless interface. The computing platform 500 is shown as interfacing to a server 522 and a third party system 524 through the network 520. A battery or power source 528 provides power for the computing platform 140.

In the description and claims of the present application, each of the verbs, “comprise” “include” and “have”, and conjugates thereof, are used to indicate that the object or objects of the verb are not necessarily a complete listing of members, components, elements, or parts of the subject or subjects of the verb.

Various aspects and embodiments of the invention have been described and have been provided by way of example. Such aspects, embodiments, features, etc., are not intended to limit the scope of the invention but rather to provide an overall understanding of the various elements that can be included in various embodiments. The described embodiments comprise different features, not all of which are required in all embodiments. Some embodiments utilize only some of the features or possible combinations of the features. Variations of embodiments described and embodiments comprising different combinations of features noted in the described embodiments will occur to persons of the art.

What is claimed is:

1. A system for measuring the distance between a reference point and a target surface, the system comprising:
a signal generator that is configured to generate a signal and transmit the signal through a medium towards the target surface, the target surface comprising a substance that will reflect the signal;
a detector that is configured to detect signals;
a processing unit that is communicatively coupled to the detector and configured to:
receive a calibration signal, wherein the calibration signal is an output of the detector generated by the detection of a reflection of the generated signal resulting from the generated signal striking a calibrated-constrictive element that is located at a known position relative to the reference point;
receiving a measurement signal, wherein the measurement signal is an output of the detector generated by the detection of a reflection of the generated signal resulting from the generated signal striking the target surface;
determine the propagation speed of the calibration signal; and
generating a measurement of the distance between the reference point and the target surface based on the time the measurement signal was received and the determined propagation speed.

2. The system of claim 1, wherein the system further comprises a tube associated with the signal generator and a detector being associated with a proximate end of the tube and the target surface being associated with a distal end of the tube, the calibrated-constrictive element being positioned at a known position within the tube and, the generated signal being propagated through the tube.

3. The system of claim 2, wherein the calibrated-constrictive element is suspended at the known position in the tube.

4. The system of claim 2, wherein the calibrated-constrictive element is fixed at the known position in the tube.

5. The system of claim 1, wherein the target surface is a liquid in a void and, the signal generator and detector being associated with a proximate end of the void and the target surface being associated with a distal end of the void, the calibrated-constrictive element being positioned at a known position within the void and, the generated signal being propagated through the void.

6. The system of claim 5, wherein the void is a container.

7. The system of claim 5, wherein the void is a well.

8. The system of claim 1, wherein the target surface is a liquid in a void with a tube extending from a proximate end of the void to the target surface located at a distal end of the void and, the signal generator and detector being associated with a proximate end of the tube and the target surface being associated with a distal end of the tube, the calibrated-constrictive element being positioned at a known position within the tube and, the generated signal being propagated through the tube.

9. The system of claim 8, wherein the void is a container.

10. The system of claim 8, wherein the void is a well.

11. The system of claim 1, wherein the system is an acoustic-pulse-reflectometry system and the signal is an acoustic signal.

12. The system of claim 1, wherein the calibrated-constrictive element is a ring.

13. An apparatus for measuring the distance between a reference point and a target surface, the apparatus comprising:
a signal generator that is configured to generate a signal and transmit the signal through a medium towards the target surface, the target surface comprising a substance that will reflect the signal;
a detector that is configured to detect signals;
a processing unit that is communicatively coupled to the detector and configured to:
receive a calibration signal, wherein the calibration signal is an output of the detector generated by the detection of a reflection of the generated signal resulting from the generated signal striking a calibrated-constrictive element that is located at a known position relative to the reference point;
receiving a measurement signal, wherein the measurement signal is an output of the detector generated by the detection of a reflection of the generated signal resulting from the generated signal striking the target surface;
determine the propagation speed of the calibration signal; and
generating a measurement of the distance between the reference point and the target surface based on the time the measurement signal was received and the determined propagation speed;
can output interface for provided the generated distance measurement.

14. The apparatus of claim 13, wherein the signal generator comprises a digital-to-analog converter, an amplifier and a transducer,
the processing unit having an output and configured to generate and provide a digital signal on the output,
the digital-to-analog converter having an input and an output, the input being coupled to the output of the processing unit, the digital-to-analog converter configured to receive and convert the digital signal and provide an analog signal based on the received digital signal to the output,
the amplifier having an input and an output, the input being coupled to the output of the digital-to-analog converter, the amplifier configured to amplify the analog signal received from the digital-to-analog converter and provide the amplified analog signal to the output; and
the transducer having an input coupled to the output of the amplifier and being operable to receive the amplified analog signal and create the generated signal.

15. The apparatus of claim 14, wherein the transducer is a speaker and the generated signal is an acoustic signal.

16. The apparatus of claim 13, wherein the detector comprises an analog-to-digital converter, an amplifier and a transducer,
the transducer having an output and being configured to detect a signal and generate an analog signal based on the detected signal on the output;
the amplifier having an input and an output, the input being coupled to the output of the transducer and being configured to receive the analog signal, amplify the analog signal, and provide the amplified analog signal to the output;
the analog-to-digital converter having an input and an output, the input being coupled to the output of the amplifier and being configured to receive the amplified analog signal, convert the amplified analog signal to a digital signal and, provide the digital signal to the output;
the processing unit having an input coupled to the output of the analog-to-digital converter and configured to receive the digital signal.

17. The apparatus of claim 16, wherein the transducer is a microphone and the detected signal is an acoustic signal.

18. The apparatus of claim 16, wherein the processing unit is further configured to identify a first received digital signal as a calibration signal, store the calibration signal in memory along with a time stamp and, identify a subsequent digital signal as a measurement signal and store the measurement signal in memory along with a time stamp.

19. The apparatus of claim 18, wherein the processing unit is configured to determine the propagation speed of the calibration signal by determining a time offset between the time stamp of the calibration signal and a known time at which the generated signal was transmitted and then determining the speed of the generated signal and calibration signal.

20. The apparatus of claim 19, wherein the processing unit is configured to generate a measurement of the distance between the reference point and the target surface by determining a time offset between the time stamp of the measurement signal and the known time at which the generated signal was transmitted and using the determined propagation speed to determine the distance.

21. A method for making a measurement of the distance between a known point and target surface of a substance in a void, the method comprising the acts of:
generating an acoustic signal at a known position relative to a reference point;
injecting the acoustic signal into a proximate end of the void toward the distal end;
receiving a calibration signal, wherein the calibration signal is a reflection of the acoustic signal resulting from the acoustic signal striking a calibrated-constrictive element that is located at a known position relative to the reference point;
receiving a measurement signal, wherein the measurement signal is a reflection of the acoustic signal resulting from the acoustic signal striking the target surface;
determining the propagation speed of the calibration signal; and
generating a measurement of the distance between the reference point and the target surface based on the time the measurement signal was received and the determined propagation speed.

22. The method of claim 21, wherein the acoustic signal is generated by exciting a speaker and the calibration signal and measurement signals are received by a microphone located at a known position relative to the reference point and, the acts of receiving a calibration signal and a measure signal further comprise the respective signal exciting the microphone to generate an analog signal, a detector converting the analog signal to a digital signal and, a processing unit receiving the digital signal and recording an event with a time stamp representing the reception of the digital signal.
